(19) United States
(12) Patent Application Publication
(10) Pub. No.: US 2022/0247891 A1
(43) Pub. Date: Aug. 4, 2022

(54) PROCESSING METHOD AND PROCESSING DEVICE

(71) Applicant: Lenovo (Beijing) Limited, Beijing (CN)

(72) Inventors: Yifei SONG, Beijing (CN); Hui WANG, Beijing (CN)

(21) Appl. No.: 17/552,440

(22) Filed: Dec. 16, 2021

(30) Foreign Application Priority Data
Jan. 29, 2021 (CN) 202110128583.6

(51) Int. Cl. H04N 5/06

(52) U.S. Cl. CPC H04N 5/06

(57) ABSTRACT

A processing method includes obtaining an input signal through a first interface. The input signal includes a video stream signal. The method further includes obtaining image content of the video stream signal by using a preview function of the virtual camera and displaying final image content through a display screen.

### CROSS-REFERENCE TO RELATED APPLICATION

This application claims priority to Chinese Patent Application No. 202110128583.6, filed on Jan. 29, 2021, the entire content of which is incorporated herein by reference.

### TECHNICAL FIELD

The present disclosure generally relates to the display processing technology field and, more particularly, to a processing method and a processing apparatus.

### BACKGROUND

With the development of display processing technology and the diverse user requirements, an electronic apparatus such as a television is used as a display to output a video stream signal accessed from an external source apparatus. However, the TV is large in size and not easy to carry. A tablet has an appropriate size and is easy to carry. But when the tablet is used as a display screen to output the video stream signal accessed by the external source apparatus, a chip for processing the video stream signal needs to be added to the tablet. Manufacturing cost is high.

### SUMMARY

Embodiments of the present disclosure provide a processing method. The method includes obtaining an input signal through a first interface. The input signal includes a video stream signal. The method further includes obtaining image content of the video stream signal by using a preview function of a virtual camera and displaying final image content through a display screen.

Embodiments of the present disclosure provide a processing device, including an acquisition unit, an image processing unit, and a display unit. The acquisition unit is configured to obtain an input signal through a first interface. The input signal includes a video stream signal. The image processing unit is configured to obtain image content of the video stream signal by using a preview function of a virtual camera. The display unit is configured to display final image content through a display screen.

Embodiments of the present disclosure provide an electronic apparatus, including a processor and a memory. The memory stores a computer program that, when executed by the processor, causes the processor to obtain an input signal through a first interface. The input signal includes a video stream signal. The processor is further caused to obtain image content of the video stream signal by using a preview function of a virtual camera and display final image content through a display screen.

### BRIEF DESCRIPTION OF THE DRAWINGS

FIG. 1 illustrates a schematic flowchart of a processing method according to some embodiments of the present disclosure.

FIG. 2 illustrates a schematic structural block diagram of a processing device according to some embodiments of the present disclosure.

FIG. 3 illustrates a schematic structural diagram of an electronic apparatus according to some embodiments of the present disclosure.

### DETAILED DESCRIPTION OF THE EMBODIMENTS

To make the objectives, technical solutions, and advantages of embodiments of the present disclosure clearer, the technical solutions of embodiments of the present disclosure are described in detail in connection with the accompanying drawings of embodiments of the present disclosure. Apparently, described embodiments are some embodiments of the present disclosure rather than all embodiments. Based on the described embodiments of the present disclosure, all other embodiments obtained by those of ordinary skill in the art without creative efforts are within the scope of the present disclosure.

Unless otherwise defined, the technical terms or scientific terms used in the present disclosure should include the general meanings understood by those of ordinary skill in the art of the present disclosure. The terms “first,” “second,” and another similar word used in the present disclosure do not represent any order, quantity or importance, but are only used to distinguish different components. The terms “include,” or “contain,” and other similar words mean that the element or item appearing before the words include the element or item listed after the words and their equivalents but do not exclude other elements or items. Similar the terms such as “connected” or “coupled” are not limited to physical or mechanical connections but may include electrical connections, whether direct or indirect. The terms “up,” “down,” “left,” “right,” etc. are only used to indicate the relative position relationship. When the absolute position of the described object changes, the relative position relationship may also change accordingly.

To keep the following description of embodiments of the present disclosure clear and simple, in the present disclosure, detailed descriptions of known functions and known components are omitted.

Embodiments of the present disclosure provide a processing method. The processing method may be applied to an electronic apparatus having a display screen. When the electronic apparatus obtains a video stream input signal, the electronic apparatus may obtain image content of the video stream signal by using a preview function of the virtual camera. Then, the image content may be displayed on the display screen. Thus, the electronic apparatus may smoothly switch and play the electronic content corresponding to the input signal.

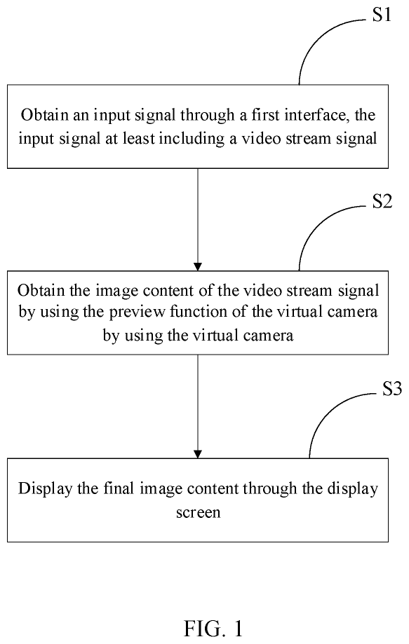

FIG. 1 illustrates a schematic flowchart of a processing method according to some embodiments of the present disclosure. As shown in FIG. 1, the processing method according to embodiments of the present disclosure includes the following steps.

At S1, an input signal is obtained through a first interface, and the input signal at least includes a video stream signal.

In the present disclosure, the first interface of the electronic apparatus may include a display interface, which is configured to transmit an audio or video signal from the source apparatus to the electronic apparatus. A common interface type may include, but is not limited to, a high-definition multimedia interface (HDMI), a DisplayPort (DP), or a mobile industry processor interface (MIPI) display serial interface (DSI).

In this step, when the first interface of the electronic apparatus is externally connected to the source device of outputting a signal through the cable, the electronic apparatus may obtain the input signal through the first interface. In some embodiments, the input signal may include the video stream signal so that the content corresponding to the video stream signal can be input to the electronic apparatus and played by the electronic apparatus.

At S2, the image content of the video stream signal is obtained by using the preview function of the virtual camera.

In this step, after obtaining the input signal having the video stream signal, the electronic apparatus may obtain the image content of the video stream signal by using the preview function of the virtual camera. For analyzing the video stream signal of the input signal to playback at the electronic apparatus, the electronic apparatus should first obtain the image content of the video stream signal. In some embodiments, image data of the video stream signal may be transmitted to the virtual camera by activating the virtual camera. Then, a preview function of the virtual camera may be turned on to obtain the image content received by the virtual camera.

At S3, the final image content is displayed through the display screen.

In this step, the image content obtained by using the preview function of the virtual camera may be displayed at the display screen after being processed by an image display module assembly of the android system. Thus, the electronic apparatus may smoothly switch and play the playback content of the source device on the display screen. In some embodiments, the image content obtained by using the preview function of the virtual camera may be transmitted to the display module assembly after the framework combines related services. The display module assembly may at least include a view, a surface flinger, a frame buffer, and an LCD driver. The view may be drawn by using the image content obtained by using the preview function of the virtual camera. The view may be submitted to the surface flinger for synthesis. Synthesized image data may be temporarily stored in the frame buffer. The LCD driver may be configured to refresh the image data on the display screen, thereby presenting the final image content on the display screen.

Through the processing method of embodiments of the present disclosure, the video stream signal of the external input signal may be smoothly output. An additional chip for processing the video stream signal may not need to be produced. The image content of the video stream signal may be obtained by using the preview function of the virtual camera. The cost is low. The processing method may adapt to the video signals from various sources, which improves the user experience.

In some embodiments, obtaining the image content of the video stream signal by using the preview function of the virtual camera may include calling the virtual camera and enabling the preview to obtain the image content for the video stream signal. In embodiments of the present disclosure, after obtaining the video stream signal through the first interface, the electronic apparatus may convert the image signal of the video stream signal into a data signal of a corresponding format output by the CSI to transmit image information of the video stream signal through the MIPI CSI.

Before using the preview function of the virtual camera to obtain the image content of the video stream signal, a virtual camera assembly may need to be created first. The virtual camera assembly may include a virtual camera, a camera driver, and a camera module at the hardware abstraction layer (HAL). When the image content of the video stream signal needs to be obtained by using the preview function of the virtual camera, by calling the virtual camera through the HAL, in some embodiments, interface information of the virtual camera may be obtained first. The electronic apparatus may turn on the virtual camera and adjust parameter information of the virtual camera through the interface information. After the camera driver receives data parameters of the image content transmitted by the MIPI CSI, the HAL layer may receive the related information of the image content reported by the camera driver. The electronic apparatus may receive the image data of the video stream signal through the preview function of the virtual camera to obtain the image content of the video stream signal.

In some embodiments, the input signal may at least include the video stream signal. Obtaining the input signal through the first interface may include obtaining the input signal having the video stream signal and the audio stream signal through the first interface. The processing method may further include performing matching processing on the video stream signal and audio stream signal, displaying the image content on the display screen, and synchronously outputting audio through an audio output device. In the present disclosure, the signal input through the first interface of the electronic apparatus may include both the video stream signal and the audio stream signal. In order to collect the audio stream signal, a format of audio data of the audio stream signal obtained from the first interface may be converted into an I2S format first. Thus, the audio data may be output through the I2S interface based on an I2S protocol. The audio data transmitted through the I2S interface may be further transmitted to the audio processing chip for processing. In some embodiments, the audio data may be transmitted to an I2S driver through the I2S interface and then transmitted to Alsa (an audio driver). After obtaining the audio data, Alsa (the audio driver) may report the audio data to the HAL. After the HAL audio data is synthesized by an audio flinger (AF), the corresponding audio may be output through Media. In embodiments of the present disclosure, to keep the video stream signal and audio stream signal of the input signal synchronized during output, the matching processing may need to be performed on the video stream signal and the audio stream signal to display the image content on the display screen and synchronically output the audio through the audio output device.

In some embodiments, performing the matching processing on the video stream signal and the audio stream signal may include obtaining video frames of the video stream signal and audio frames of the audio stream signal separately and marking the video frames and the audio frames with a timestamp.

In some embodiments, when the video stream signal is collected, each video frame of the video stream signal may be recorded, and each video frame may be marked with a timestamp. Similarly, when the audio stream signal is collected, each video frame of the audio stream signal may be recorded, and each audio frame may be marked with a time stamp.

In embodiments of the present disclosure, each frame of the video frames and each frame of the audio frames may be marked by a first timestamp. For example, the timestamp of the first video frame may be used as a start timestamp, and then the second video frame, the third video frame, . . . , and the last video frame may be marked sequentially with corresponding timestamps. Thus, the video frames may be marked through the first timestamp. The same method may be used to mark the audio frames, with the timestamp of the first audio frame as the start timestamp. Then, the second audio frame, the third audio frame, . . . , and the last audio frame may be sequentially marked and stamped with corresponding timestamps. Thus, the audio frames may be marked through the first timestamp. After the marking is completed, in embodiments of the present disclosure, to display the image content on the display screen and output the audio synchronously through the audio output device, based on the first timestamp marked on each frame, the corresponding video frame and the audio frame may be output. Thus, the electronic apparatus may synchronously display the image content and output the corresponding audio.

In embodiments of the present disclosure, some frames of the video frames and some frames of the corresponding audio frames may also be marked by a second timestamp. For example, a timestamp of another video frame other than the first video frame may be used as the start timestamp. Then based on a predetermined time interval, the subsequent video frames are sequentially marked with corresponding timestamps. Thus, the video frames may be marked through the second timestamp. Meanwhile, the same method may be used to mark the audio frames. A timestamp of an audio frame corresponding to the another video frame may be used as the start timestamp. Then, based on the predetermined time interval, the subsequent audio frames are sequentially marked with the corresponding timestamps. Thus, the audio frames may be marked through the second timestamp. After the marking is completed, in some embodiments of the present disclosure, to display the image content on the display screen and output the audio through the audio output device synchronously, based on the second timestamp marked on some frames, the electronic apparatus may synchronously display the image content and output the audio of the frame, which is used as the start frame. The electronic apparatus may output the corresponding video frames and audio frames to display the image content and outputting the corresponding audio synchronously.

In some embodiments, displaying the image content on the display screen and synchronously outputting the audio through the audio output device may include adjusting output time and an output sequence of the image content and the corresponding audio information according to a relative timestamp. In embodiments of the present disclosure, the corresponding audio frame may be marked with the relative timestamp based on the obtained video frames. In some other embodiments, the corresponding video frames may also be marked with the relative timestamp based on the obtained audio frames. As such, when outputting the image content, the electronic apparatus may adjust the output time and output sequence of the corresponding audio frames according to the relative timestamp. Alternatively, when outputting the audio content, the electronic apparatus may adjust the output time and output sequence of the image content corresponding to the corresponding video frames according to the relative timestamp. Thus, the electronic apparatus may synchronously display the image content and the corresponding audio.

In some embodiments, before displaying the final image content on the display screen, the method further may include, based on the apparatus parameters of the display screen, adjusting an image format change by processing image attribute information to adapt to the display screen. In some embodiments, the size and resolution of the image content may be adjusted according to the size of the display screen so that the output image content can be displayed on the display screen in full screen.

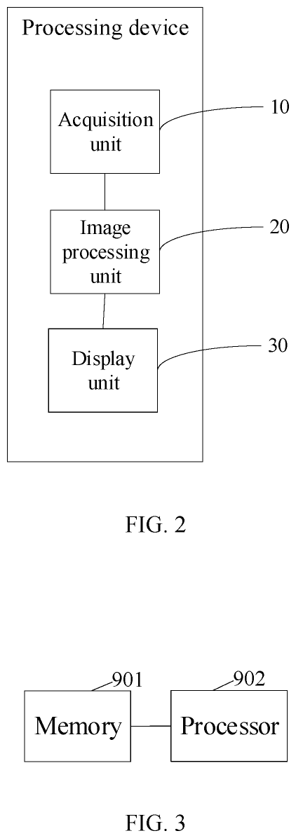

Embodiments of the present disclosure further provide a processing device. As shown in FIG. 2, the processing device includes an acquisition unit 10, an image processing unit 20, and a display unit 30.

The acquisition unit 10 may be configured to obtain the input signal through the first interface. The input signal may include at least the video stream signal.

In this step, the acquisition unit 10 may obtain the input signal from the first interface. In some embodiments, the input signal may include the video stream signal. Thus, the content corresponding to the video stream signal may be input to the acquisition unit 10 to process the input signal.

The image processing unit 20 may be configured to obtain the image content of the video stream signal by using the preview function of the virtual camera.

In this step, after the acquisition unit 10 obtains the input signal, including the video stream signal, the image processing unit 20 may obtain the image content of the video stream signal by using the preview function of the virtual camera. To analyze the video stream signal of the input signal, the image processing unit 20 may need to obtain the image content of the video stream signal first. In some embodiments, the image processing unit 20 may transmit the image data of the video stream signal to the virtual camera by turning on the virtual camera. Then, the image processing unit 20 may turn on the preview function of the virtual camera to obtain the image content received by the virtual camera.

The display unit 30 may be configured to display the final image content through the display screen.

In this step, the image content obtained by using the preview function of the virtual camera may be displayed on the display screen after being processed by an image display module assembly of the display unit 30. Thus, the processing device may smoothly switch and display the playback content of the source device on the display screen. In some embodiments, the image content obtained by using the preview function of the virtual camera may be transmitted to the display module assembly of the display unit 30 after the framework combines the related services. The display module assembly may at least include the view, the surface flinger, the frame buffer, and the LCD driver. The view may be drawn by using the image content obtained by using the preview function of the virtual camera. The view may be reported to the surface flinger for synthesis. Synthesized image data may be temporarily stored in the frame buffer. The LCD driver may be configured to refresh the image data on the display screen, thereby presenting the final image content on the display screen.

Based on the same concept, embodiments of the present disclosure further provide an electronic apparatus. FIG. 3 illustrates a schematic structural diagram of the electronic apparatus according to some embodiments of the present disclosure. The electronic apparatus at least includes a memory 901 and a processor 902. The memory 901 may store a computer program. The processor 902 may execute the computer program stored in the memory 901 to implement the processing method of embodiments of the present disclosure.

In some embodiments, for specific examples of embodiments of the present disclosure, reference may be made to the examples described in any of the above embodiments, which are not repeated here.

In addition, although exemplary embodiments have been described here, their scope may include any and all embodiments with equivalent elements, modifications, omissions, combinations (for example, cross-over schemes of various embodiments), adaptations, or changes based on the present disclosure. The elements in the claims will be interpreted broadly based on the language adopted in the claims and are not limited to the examples described in this specification or the examples described when the present disclosure is implemented. The examples will be interpreted as non-exclusive. Therefore, the present specification and the examples are intended to be regarded as examples only. The true scope and spirit are indicated by the following claims and the full scope of their equivalents.

The above description is intended to be illustrative and not restrictive. For example, the above examples (or one or more solutions) may be combined with each other for use. For example, those of ordinary skill in the art may use other embodiments when reading the above description. In addition, in specific embodiments, various features may be grouped together to simplify the present disclosure. This should not be interpreted as an intent that an unclaimed disclosed feature is necessary for any claim. On the contrary, the subject matter of the present disclosure may include features less than all the features of a disclosed embodiment. Thus, the following claims may be used as examples or embodiments to be incorporated into the specific embodiments. Each claim may be independently used as a separate embodiment. These embodiments may be combined with each other in various combinations or arrangements. The scope of the present disclosure should be determined with reference to the full scope of the appended claims and equivalent forms of these claims.

Embodiments of the present disclosure are described in detail above, but the present disclosure is not limited to these specific embodiments. Those skilled in the art may make various variations and modifications of embodiments based on the concept of the present disclosure. These variations and modifications should be within the scope of the present disclosure.

What is claimed is:

1. A processing method comprising:
obtaining an input signal through a first interface, the input signal including a video stream signal;
obtaining image content of the video stream signal by using a preview function of a virtual camera; and
displaying final image content through a display screen.

2. The method according to claim 1, wherein obtaining the image content of the video stream signal by using the preview function of the virtual camera includes:
calling the virtual camera; and
enabling a preview of the video stream signal by the virtual camera to obtain the image content.

3. The method according to claim 2, wherein calling the virtual camera includes:
obtaining interface information of the virtual camera; and
turning on the virtual camera and adjusting parameter information of the virtual camera through the interface information to receive the video stream signal.

4. The method of claim 1,
wherein obtaining an input signal through a first interface includes:
obtaining the input signal including the video stream signal and an audio stream signal through the first interface;
the method further comprising:
performing matching processing on the video stream signal and the audio stream signal; and
displaying the image content on the display screen and outputting an audio through an audio output device synchronously.

5. The method according to claim 4, wherein performing the matching processing on the video stream signal and the audio stream signal includes:
obtaining video frames of the video stream signal and audio frames of the audio stream signal separately; and
marking the video frames and the audio frames separately with a timestamp.

6. The method according to claim 5, wherein marking the video frames and the audio frames separately with the timestamp includes:
marking each frame of the video frames and each frame of the audio frames with a first timestamp; or
marking some frames of the video frames and some frames of the audio frames with a second timestamp.

7. The method according to claim 6, wherein displaying the image content on the display screen and synchronously outputting the audio through the audio output device includes:
based on the first timestamp marked on each frame, synchronously displaying the image content and outputting the audio; or
based on the second timestamp marked on the some frames, synchronously displaying the image content and outputting the audio of a frame of the second timestamp as a start frame.

8. The method according to claim 5, wherein displaying the image content on the display screen and synchronously outputting the audio through the audio output device includes:
adjusting output time and an output sequence of the image content and corresponding audio information according to a relative timestamp.

9. The method according to claim 1, further comprising, before displaying of the final image content on the display screen:
based on apparatus parameters of the display screen, processing image attribute information to adjust an image format change to adapt to the display screen.

10. A processing device comprising:
an acquisition unit configured to obtain an input signal through a first interface, the input signal including a video stream signal;
an image processing unit configured to obtain image content of the video stream signal by using a preview function of a virtual camera; and
a display unit configured to display final image content through a display screen.

11. The processing device according to claim 10, wherein the image processing unit is further configured to:
call the virtual camera; and
enable a preview of the video stream signal by the virtual camera to obtain the image content.

12. The processing device according to claim 11, wherein the image processing unit is further configured to:
obtain interface information of the virtual camera; and
turn on the virtual camera and adjust parameter information of the virtual camera through the interface information to receive the video stream signal.

13. The processing device of claim 10, wherein:
the acquisition unit is further configured to obtain the input signal including the video stream signal and an audio stream signal through the first interface; and
the display unit is further configured to:
perform matching processing on the video stream signal and the audio stream signal; and
display the image content on the display screen and output an audio through an audio output device synchronously.

14. The processing device according to claim 13, wherein the display unit is further configured to:
obtain video frames of the video stream signal and audio frames of the audio stream signal separately; and
mark the video frames and the audio frames separately with a timestamp.

15. The processing device according to claim 14, wherein the display unit is further configured to:
mark each frame of the video frames and each frame of the audio frames with a first timestamp; or
mark some frames of the video frames and some frames of the audio frames with a second timestamp.

16. The processing device according to claim 15, wherein the display unit is further configured to:
based on the first timestamp marked on each frame, synchronously display the image content and output the audio; or
based on the second timestamp marked on the some frames, synchronously display the image content and output the audio of a frame of the second timestamp as a start frame.

17. The processing device according to claim 14, wherein the display unit is further configured to:
adjust output time and an output sequence of the image content and corresponding audio information according to a relative timestamp.

18. The processing device according to claim 10, wherein the image processing unit is further configured to:
based on apparatus parameters of the display screen, process image attribute information to adjust an image format change to adapt to the display screen.

19. An electronic apparatus comprising:
a processor; and
a memory storing a computer program that, when executed by the processor, causes the processor to:
obtain an input signal through a first interface, the input signal including a video stream signal;
obtain image content of the video stream signal by using a preview function of a virtual camera; and
display final image content through a display screen.

20. The electronic apparatus according to claim 19, wherein the processor is further caused to:
call the virtual camera; and
enable a preview of the video stream signal by the virtual camera to obtain the image content.
